(19) United States
(12) Patent Application Publication
(10) Pub. No.: US 2006/0268537 A1
(43) Pub. Date: Nov. 30, 2006

(54) Phosphor film, lighting device using the same, and display device

(76) Inventors: Makoto Kurihara, Chiba-shi (JP); Norihiro Dejima, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/430,615

(22) Filed: May 9, 2006

(30) Foreign Application Priority Data
May 31, 2005 (JP) 2005-159132
Jun. 23, 2005 (JP) 2005-182851

(51) Int. Cl. F21K 2/00

(52) U.S. Cl. 362/34

(57) ABSTRACT

The invention realizes a phosphor film that has a fluorescent characteristic excellent in resistance to humidity and provides, using the phosphor film, a liquid crystal display device that is excellent in resistance to humidity and has satisfactory calorimetric property and color mixture property. Phosphor particles that are excited by incident light and emit light having a wavelength different from the incident light are mixed in a binder. The binder mixed with the phosphor particles is sandwiched between a translucent film and a non-permeable layer as a phosphor layer to form a phosphor film. This phosphor film is provided at least in one place among a place between a light source and a light guide of a lighting device, a place on a light irradiation surface of the light guide, and a place between the light guide and a reflection plate. Moreover, the phosphor particles have a characteristic that a wavelength absorbed by a color filter of a display element is set as an excitation wavelength and a luminescent wavelength is in a region transmitted by the color filter. With this phosphor film, it is possible to realize a display device that has extremely high luminance efficiency and color reproducibility.

### BACKGROUND OF THE INVENTION

1. Field of the Invention

The present invention relates to a lighting device for lighting display elements used in a portable information apparatus, a cellular phone, and the like and a display device using the lighting device, and more particularly, to a phosphor film used in the lighting device.

2. Related Background Art

In recent years, a liquid crystal display device, which obtains a high definition color image with small power consumption, is employed as a display device used in a cellular phone, a mobile computer, and the like. The liquid crystal display device requires a lighting device because the liquid crystal display device is a non-self luminescent display device that does not emit light. A superluminescent white LED is often used as a light source in the lighting device.

In particular, in a cellular phone, a reflection-type liquid crystal display device that has a large and bright opening or a double-side visible type liquid crystal display device that is capable of displaying image information on both front and rear sides thereof is used. The lighting device that uses the superluminescent white LED is often employed to light liquid crystal elements used in the liquid crystal display device. In the white LED, in general, a green phosphor or a yellow phosphor dispersed in resin is arranged on a light-emitting surface of a blue LED element serving as a light source. Green light or yellow light obtained from the green phosphor or the yellow phosphor is mixed with blue light of the blue LED element to obtain white light (see, for example, JP 10-107325 A.) It is known that, in the white LED with such a structure, since intensity of light irradiated on the phosphor is high, the phosphor is applied and formed on a rear surface of a light guide at a predetermined formation density in order to prevent photo-deterioration of the phosphor (see, for example, JP 7-176794 A). Moreover, it is known that a laminated wavelength conversion member is provided between a blue LED element and a light incidence surface of a light guide in order to perform wavelength conversion with a phosphor in a smaller area (see, for example, JP 10-269822 A).

The liquid crystal display device selects a necessary color from light, which is emitted from the white LED, using color filters of red (R), green (G), and blue (B) provided in a liquid crystal panel and a switching function of the liquid crystal elements and displays the color.

FIG. 21 is a chromaticity diagram for explaining luminescent colors in the case in which yellow phosphor particles that convert blue light into yellow light are used. Yellow light excited by blue light (chromaticity 44 in the figure) is indicated by chromaticity 45. Therefore, it is possible to obtain a luminescent color of arbitrary chromaticity on a line connecting the chromaticity 44 and the chromaticity 45 by changing intensity of the blue light or adjusting a concentration of the yellow phosphor particles to adjust a ratio of blue light intensity to the yellow light intensity. In this case, strictly speaking, since components other than the yellow light are included in light obtained by converting the blue light, it is possible to represent chromaticity on a line having a width that connects the chromaticity 44 and the chromaticity 45. However, since the line connecting the chromaticity 44 and the chromaticity 45 is not wide enough, colors that can be reproduced using only the blue light and the yellow phosphor cannot represent the entire range of a large color triangle 103 indicated by RGB in FIG. 21.

In order to solve this problem, it is preferable that phosphor particles obtained by mixing green phosphor particles that convert blue light into green light and red phosphor particles that convert blue light into red light at a predetermined ratio are mixed in a binder and used. As such phosphor particles, so-called chalcogenide compound phosphor particles such as an S compound, an Se compound, or Te compound doped with a rare earth element are suitable. A chromaticity diagram in this case is shown in FIG. 20. In FIG. 20, green phosphor particles excited by blue light of chromaticity 41 emit green light of chromaticity 42. Red phosphor particles excited by blue light of chromaticity 41 emit red light of chromaticity 43. Luminescent intensities of the green light and the red light depend upon wavelength conversion efficiency and mixture concentration of the green phosphor particles and the red phosphor particles and intensity of the blue light serving as excitation light. Therefore, it is possible to obtain light corresponding to all colors in a triangle connecting the chromaticity 41, the chromaticity 42, and the chromaticity 43 by adjusting the mixture ratio and the mixture concentration of the green phosphor particles and the red phosphor particles and changing the blue light intensity. It is seen that, since this triangle occupies the most part of the color triangle 103 indicated by RGB, a display color range is increased.

However, when the chalcogenide compound phosphor particles absorb moisture, characteristics thereof tend to deteriorate. Thus, it is difficult to use the chalcogenide compound phosphor particles regularly.

In this way, in the case of the conventional method of wavelength-converting light from a light source using a film applied with a phosphor to obtain white light according to additive mixture color stimuli, in particular, when a so-called chalcogenide phosphor obtained by doping a rare earth element in an S compound, an Se compound, a Te compound, or the like having high light conversion efficiency is used, the phosphor is deteriorated by moisture in the environment. Thus, it is impossible to perform efficient color mixture over a long period of time.

### SUMMARY OF THE INVENTION

It is an object of the present invention to realize a phosphor film that has a long life even when a chalcogenide phosphor is used and to provide, by using this phosphor film, a liquid crystal display device that does not have a significant influence on design of a light guide and has an efficient wide color reproduction range.

A wavelength distribution of the conventional white LED used in the lighting device of the liquid crystal display device spreads broadly with peaks at 450 nm and 580 nm because light emitted by the white LED is white light of a mixed color obtained by mixing blue color light and green color light. On the other hand, peaks of wavelength selected by a color filter used in the liquid crystal display device or the like are 450 nm for blue, 530 nm for green, and 600 nm for red. In other words, in light from a white light source, wavelengths of 480 nm to 510 nm and 570 nm to 590 nm are cut and the light having the wavelengths cut is absorbed by the color filter. Thus, it is another object of the invention to provide a lighting device that effectively uses wavelengths of components cut by the color filter and realizes luminance efficiency and extremely high color reproducibility.

In the phosphor film according to the invention, a phosphor layer applied with phosphor particles mixed in a binder is formed on a translucent film base material and the surface of the phosphor layer is coated with a non-permeable layer. The non-permeable layer is made of the non-water-permeable material, and prevents the phosphor layer from moisture.

The lighting device according to the invention includes a phosphor film in which a phosphor layer applied with phosphor particles mixed in a binder is formed on a translucent base material. In the phosphor particles, a wavelength absorbed by the color filter is an excitation wavelength. A luminance wavelength of the phosphor particles belongs to a region of wavelengths transmitted by the color filter.

When the translucent film is thin, it is possible to isolate the phosphor layer from moisture in the environment by forming the translucent film itself from a non-permeable material or forming a second non-permeable layer on the translucent film, applying a phosphor layer over the second non-permeable layer, and further coating the phosphor layer with a first non-permeable layer. As a result, it is possible to keep characteristics of the phosphor particles over a long period of time.

A lighting device according to the present invention includes: a light source; phosphor particles that are excited by light from the light source and emit light having a wavelength different from that of the light from the light source; a light guide that propagates the light from the light source and irradiates the light in a plane shape; and a phosphor layer formed by mixing the phosphor particles in a binder, in which the phosphor layer is sandwiched between a translucent film and a non-permeable layer.

Moreover, an optical element is provided on an emission surface side of the light guide, and the phosphor particles are excited by light in a region, which does not pass through the optical element, of a wavelength region of the light emitted from the light source and emit light having a wavelength passing through the optical element.

In this case, the phosphor layer is provided either between the light source and the light guide or above the emission surface of the light guide. Moreover, a reflection plate is provided on a rear side of the light guide, and the phosphor layer is provided between the light guide and the reflection plate.

Further, the light source is a blue light source, and the phosphor particles include green phosphor particles that convert blue light into green light and red phosphor particles that convert blue light into red light. Alternatively, the light source includes an ultraviolet light source and a blue light source, and the phosphor particles to be used include green phosphor particles that convert an ultraviolet ray into green light and red phosphor particles that convert an ultraviolet ray into red light.

Furthermore, the phosphor layer includes: a first phosphor layer including first phosphor particles that are excited by the light from the light source and emit light in a first wavelength range; and a second phosphor layer including second phosphor particles that are excited by the light from the light source and emit light in a second wavelength range.

Here, one of the first phosphor layer and the second phosphor layer which emits light having a short wavelength, is arranged on the light source side. Alternatively, the first phosphor layer and the second phosphor layer are arranged in a plane to prevent an overlap therebetween.

Further, when the phosphor layer is provided between the light source and the light guide, a density of mixture of the phosphor particles is set to be larger in an area closer to the light source.

Further, a light pipe is provided between the light source and the light guide to propagate the light from the light source and make the light incident on the light guide in a linear shape. The phosphor layer is formed in the light pipe, and a non-permeable layer is provided to cover an entire surface of the light pipe. The second phosphor particles may be provided between the light pipe and a light incidence surface of the light guide.

The display device according to the invention includes a light guide that emits light, which is made incident from a light source, from an emission surface and a display element provided on the emission surface side of the light guide. A phosphor layer sandwiched by a translucent film and a non-permeable layer is provided on an optical path between the light source and the display element. In the phosphor layer, phosphor particles that are excited by the light from the light source and emit light having a wavelength different from that of the light from the light source are dispersed in a binder. The phosphor particles have a characteristic that the phosphor particles are excited by light in a region, which is cut by the color filter formed in the display element, of a wavelength region of the light emitted from the light source and emit light having a wavelength that passes the color filter.

When a light source that emits pseudo-white light including two peaks in a visible light region is used and the display element has a color filter formed of a red filter, a green filter, and a blue filter, phosphor particles that are excited by light of 480 nm to 490 nm and emit light of 600 nm are used.

Alternatively, when the light source that emits pseudo-white light including two peaks in a visible light region is used, a phosphor particle that is excited by light in a wavelength region of one peak and emits light in a wavelength region other than the two peaks may be used.

### BRIEF DESCRIPTION OF THE DRAWINGS

In the accompanying drawings:

FIG. 1 is a sectional view schematically showing a structure of a phosphor film according to the present invention;

FIG. 2 is a sectional view schematically showing a structure of the lighting device according to the invention;

FIG. 3 is a sectional view schematically showing a structure of the lighting device according to the invention;

FIG. 4 is a sectional view schematically showing a structure of a display device according to the invention;

FIG. 5 is a sectional view schematically showing a structure of the lighting device according to the invention;

FIG. 6 is a graph showing a wavelength and transmittance of a color filter of a color liquid crystal panel;

FIG. 7 is a graph showing a correlation between a wavelength and intensity of a white LED;

FIG. 8 is a graph showing an example of a wavelength conversion characteristic diagram of a phosphor film used in the invention;

FIG. 9 is a graph showing a wavelength-intensity characteristic at the time when the phosphor film and the white LED are combined;

FIG. 10 is a sectional view schematically showing a structure of the phosphor film according to the invention;

FIG. 11 is a schematic diagram showing a structure of the lighting device according to the invention;

FIG. 12 is a schematic diagram showing a structure of the lighting device according to the invention;

FIG. 13 is a schematic diagram showing a structure of the lighting device according to the invention;

FIG. 14 is a schematic diagram showing a structure of the lighting device according to the invention;

FIG. 15 is a perspective view schematically showing a structure of the lighting device according to the invention;

FIG. 16 is a perspective view schematically showing a structure of the lighting device according to the invention;

FIG. 17 is a schematic diagram showing a structure of a phosphor layer used in the lighting device according to the invention;

FIG. 18 is a schematic diagram showing a structure of the phosphor layer used in the lighting device according to the invention;

FIG. 19 is a schematic diagram showing a structure of the phosphor layer used in the lighting device according to the invention;

FIG. 20 is a chromaticity diagram showing a calorimetric property of the lighting device according to the invention;

FIG. 21 is a chromaticity diagram showing a colorimetric property of a conventional lighting device; and

FIG. 22 is a sectional view schematically showing a structure of a liquid crystal display device according to the invention.

### DETAILED DESCRIPTION OF THE PREFERRED EMBODIMENTS

A phosphor film according to the present invention includes phosphor particles that are excited by light made incident thereon and emit light having a wavelength different from that of the incident light and a phosphor layer formed by mixing the phosphor particles in a binder. The phosphor layer is sandwiched between a translucent film and a non-permeable layer. This structure is shown in FIG. 1. As shown in the figure, a binder 2 with phosphor particles 4 dispersed therein is applied on a transparent film 1. A layer including the binder 2 and the phosphor particles 4 is referred to as a phosphor layer. A non-permeable layer 3 is coated over the phosphor layer in order to protect the phosphor particles 4 from moisture. According to the phosphor film with such a structure, even if a chalcogenide phosphor material is used as phosphor particles, it is possible to keep characteristics of the phosphor particles over a long period of time without being affected by moisture in the environment. Therefore, since it is possible to realize high humidity resistance even if the chalcogenide phosphor material with high color conversion efficiency is used, it is possible to use the phosphor film according to the invention as a wavelength conversion film. Consequently, it is possible to use the phosphor film for wavelength conversion for light from a light source in many applications and thereby promote a reduction in power consumption, a reduction in size, and a reduction in thickness of a color light source.

A lighting device according to the invention includes a light source, phosphor particles that are excited from light from the light source and emit light having a wavelength different from that of the light from the light source, a light guide that propagates the light from the light source and irradiates the light in a plane shape, and a phosphor layer that is formed by mixing the phosphor particles in a binder. The phosphor layer is sandwiched between a translucent film and a non-permeable layer. Since humidity resistance is improved by such a structure, it is possible to realize a lighting device that has a long life, a large colorimetric area, and high light use efficiency, and to obtain a satisfactory color lighting device for lighting a plane.

Moreover, a lighting device according to the invention includes a light source, a light guide that makes light from the light source incident thereon and emits the light from an emission surface, a phosphor film that has a translucent film whose surface is provided with a phosphor layer containing binder with a phosphor dispersed therein is provided, and an optical element provided on the emission surface side of the light guide. The phosphor has a characteristic that the phosphor is excited by light in a region that does not pass through the optical element in a wavelength region of the light emitted from the light source and emits light having a wavelength that passes through the optical element.

The phosphor film only has to be provided either between the light source and the light guide or above or below the emission surface of the light guide. A non-permeable layer may be formed in the phosphor film to cover the phosphor layer.

A display device according to the invention includes a light source, a light guide that emits light, which is made incident thereon from the light source, from an emission surface, a phosphor film that has a translucent film, whose surface is provided with a phosphor layer containing binder with a phosphor dispersed therein, and a display element provided on the emission surface side of the light guide. The phosphor has a characteristic that the phosphor is excited by light in a region, which is cut by a color filter formed in the display element, of a wavelength region of the light emitted from the light source and emits light having a wavelength that passes through the color filter. With such a structure, a calorimetric property of the element is improved and it is possible to realize a higher definition color liquid crystal display device.

Moreover, the light source emits pseudo-white light including two peaks in a visible light region, the color filter is formed of a red filter, a green filter, and a blue filter and the phosphor is excited by light of 480 nm to 490 nm and emits light of 600 nm. Alternatively, the light source emits pseudo-white light including two peaks in a visible light region and the phosphor is excited by light in a wavelength region of one of the peaks and emits light in a wavelength region other than the two peaks.

The phosphor is formed of a first phosphor that is excited by the light from the light source and emits light in a first wavelength region, and a second phosphor that is excited by the light from the light source and emits light in a second wavelength region. In this case, a phosphor that emits light having a short wavelength is arranged on the light source side. Alternatively, the first phosphor and the second phosphor are arranged not to overlap each other within a plane.

The phosphor is provided between the light source and the light guide to set a mixture density of the phosphor particles to be larger in a region closer to the light source.

Alternatively, it is possible to adjust intensity of light emitted from the light guide by changing a mixture density of the phosphor particles according to a position in the phosphor. For example, a mixture density of the phosphor particles is set to be inversely proportional to a radiance intensity distribution of the light source.

A lighting device according to the invention has a light guide that propagates light from a light source and waveform conversion light obtained by exciting phosphor particles and irradiates the light in a plane shape. The lighting device uses a phosphor film in which a phosphor layer formed by mixing and dispersing the phosphor particles in a binder is coated with a first non-permeable layer and formed in a translucent film. The phosphor layer may be coated with a first non-permeable layer and a second non-permeable layer. A blue light source is used as the light source. A green phosphor that converts blue light into green light and a red phosphor that converts blue light into red light are formed to be spatially separated from each other. A phosphor that emits light with a shorter wavelength of the two kinds of phosphors is arranged closer to the light source side. With such a structure, it is possible to perform efficient wavelength conversion using a uniform phosphor distribution without changing a propagation characteristic of the light guide. Since phosphor layers are formed to be spatially separated from each other, it is possible to arrange a phosphor layer with lower wavelength conversion efficiency near the light source. As a result, it is possible to maximize color conversion efficiency for respective colors. Moreover, since the phosphor particles are not affected by moisture in the environment, it is possible to extend a life of the lighting device itself.

An ultraviolet light source and a blue light source are used as light sources. A green phosphor layer that converts an ultraviolet ray into green light and a red phosphor layer that converts an ultraviolet ray into red light are used as phosphor layers. Consequently, it is possible to realize green light emission and red light emission with high luminance efficiency, and to realize a liquid crystal display device with a large color reproduction range by mixing the green light and the red light with the blue light.

When the ultraviolet light source is used as the light source, a phosphor layer is provided between the light source and an incidence surface of a light guide and an ultraviolet ray absorbing film is provided between the phosphor layer and the incidence surface of the light guide. With such a structure, it is possible to prevent polymeric components such as the light guide from being deteriorated by an ultraviolet ray and realize extension of a life of the lighting device.

It is possible to form a phosphor layer by mixing phosphor particles in a polymeric binder and printing in a predetermined shape or applying on a translucent film. A non-permeable layer is formed on the phosphor layer. In the phosphor layer, a first phosphor layer in which first phosphor particles are dispersed in the polymeric binder, and a second phosphor layer in which second phosphor particles are dispersed in the polymeric binder are arranged not to overlap each other in a plane. With such a structure, it is possible to perform wavelength conversion into multiple colors with one phosphor layer. Since phosphors do not overlap each other, it is possible to reduce absorption of light of one phosphor by the other phosphor and substantially improve wavelength conversion efficiency. In this case, a color mixture characteristic is improved by sufficiently reducing a size of areas where the respective phosphor layers are formed and bringing the areas close to each other to make it possible to perform wavelength conversion without color irregularity. In this way, it is possible to extend a characteristic life of the phosphors by coating the phosphor layer with the first non-permeable layer or the second non-permeable layer.

An area density of the distributed phosphor particles are set to be proportional to required excitation light intensity. This makes it possible to obtain a liquid crystal display device having a uniform color mixture ratio.

A light pipe is provided between the light source and a light guide to propagate light from the light source to be made linearly incident on the light guide, a phosphor layer is formed in the light pipe, and a non-permeable layer is provided to coat the entire surface of the light pipe.

Alternatively, the first phosphor particles and the second phosphor particles may be dispersed in the light pipe at a predetermined ratio to simultaneously perform wavelength conversion and color mixture in the light pipe. The surface of the light pipe is coated with a non-permeable layer. Since the phosphors are dispersed in the light pipe, it is possible to perform wavelength conversion within uniform and high light intensity and improve wavelength conversion efficiency. In the light pipe, since the light from the light source repeats multi-path reflection, it is also possible to improve a color mixture property of the light. Since the light pipe is coated with the non-permeable layer, it is possible to protect the phosphors from moisture in the environment and extend a life of the phosphors.

Alternatively, it is also possible that the first phosphor particles are provided in the light pipe, the non-permeable layer is provided to coat the entire surface of the light pipe, and a second phosphor is provided between the light pipe and the light incidence surface of the light guide. With such a structure, it is possible to uniformly perform mixture and dispersion of the phosphor in the light pipe and perform more uniform color conversion. Since intensity of light irradiated on the phosphor layers is also uniform, it is possible to uniformly apply the phosphor on the phosphor film. This makes it easy to manufacture the phosphor film.

The phosphor film, the lighting device, and the display device will be hereinafter explained specifically using the drawings.

### First Embodiment

A structure of a phosphor film according to a first embodiment of the invention will be explained using FIG. 1. As shown in the figure, in a phosphor film 9, the phosphor particles 4 are mixed in the binder 2 and applied on the transparent film 1. A layer including the binder 2 and the phosphor particles 4 is referred to as a phosphor layer. The non-permeable layer 3 is coated over the phosphor layer in order to protect the phosphor particles 4 from moisture.

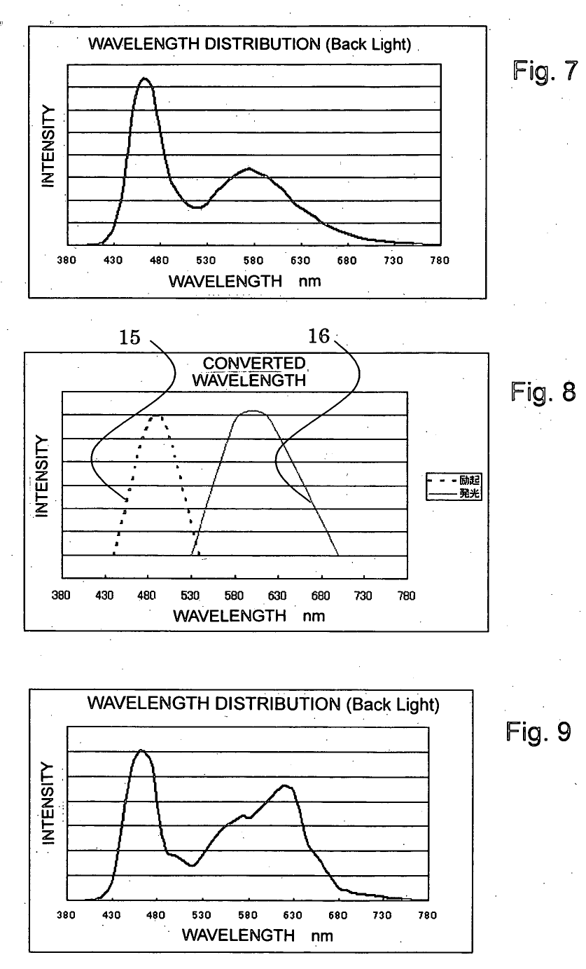

A material of the phosphor particles 4 is appropriately selected and used according to an excitation light wavelength to be used and a target luminescent wavelength. For example, when light emitted from a white LED generally used in a lighting device of a liquid crystal display device is used as excitation light, light emitted by the lighting device is referred to as pseudo-white light. A wavelength-luminance characteristic of the pseudo-white light is shown in FIG. 7. As shown in the figure, the pseudo-white light has two peaks. In this case, a phosphor that is excited by light of 480 nm to 490 nm and emits light of 600 nm is used as the phosphor particles 4. A relation of the wavelengths is shown in FIG. 8. In other words, a phosphor that is excited by light having a peak at 480 nm to 490 nm (a curve 15) and emits light having a peak at 600 nm (a curve 16) is used. A wavelength-luminance characteristic of illumination light obtained by using the pseudo-white light having the characteristic shown in FIG. 7 and the phosphor explained using FIG. 8 is shown in FIG. 9. When a phosphor having a peak of a luminescent wavelength at 625 nm where a ratio of light emission from the white LED is low is selected, it is possible to realize a wavelength distribution including light of a longer wavelength and obtain a lighting device having high color reproducibility.

The phosphor particles 4 are composed of a substrate, an activator, and a solvent. The substrate is selected out of inorganic phosphors such as an oxide and a sulfide of rare earth elements such as zinc, cadmium, magnesium, silicon, and yttrium, silicate, and vanadic acid, or organic phosphors such as fluorescein, eosin, and oils (mineral oil). The activator is selected out of silver, copper, manganese, chrome, europium, zinc, aluminum, lead, phosphorus, arsenic, and gold. The solvent is selected out of sodium chloride, potassium chloride, magnesium carbonate, and barium chloride. The transparent film 1 is formed from a translucent polymeric material having thickness of about 25 μm to 500 μm. As the translucent polymeric material, it is possible to use usual resin such as PET (polyethylene terephthalate), PC (polycarbonate), acrylic resin, and TAC (triacetyle-cellulose). As the binder 2, it is possible to use a translucent adhesive such as an acrylic adhesive or an epoxy adhesive. These adhesives may be a heat-hardening adhesive, an ultraviolet curing adhesive, or an air-setting adhesive.

### Second Embodiment

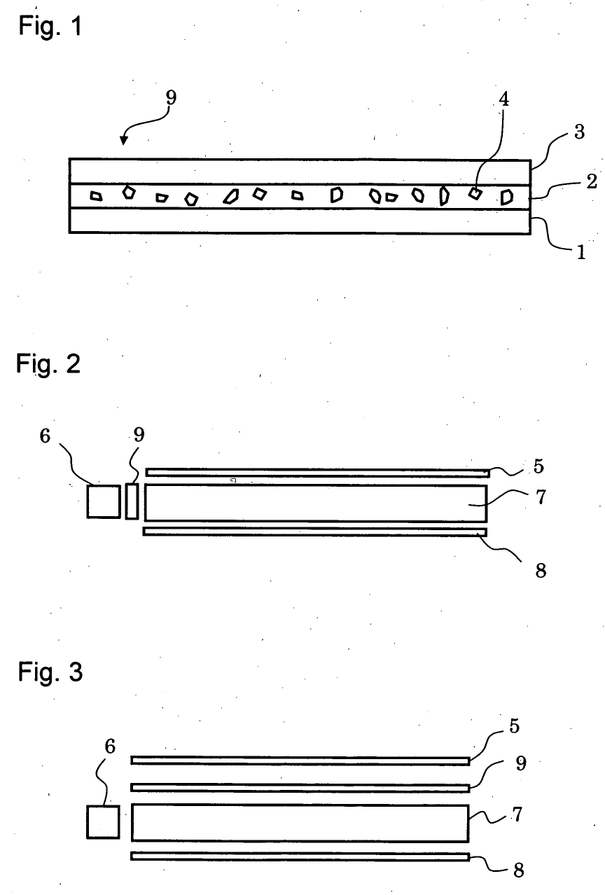

A structure of a lighting device according to a second embodiment of the invention is schematically shown in FIG. 2. The lighting device according to this embodiment is a so-called side-light type lighting device in which a light source is arranged on the side of a light guide. As shown in the figure, the phosphor film 9 is set between a light source 6 and a light guide 7. Light emitted from the light source 6 passes through the phosphor film 9 to be converted into light of a desired wavelength. The converted light is guided by the light guide 7 to be emitted from an emission surface of the lighting device by a reflection plate 8 and a prism sheet 5. As in the first embodiment, in the phosphor film 9, a phosphor layer formed by mixing phosphor particles in a binder is provided on a translucent film. The translucent film only has to be provided somewhere between the light source and the emission surface of the lighting device. A structure in which the phosphor film 9 is provided on the light guide 7 is shown in FIG. 3. In this case, light emitted from the light source 6 is guided in the light guide 7 and emitted upward from the light guide 7 by the reflection plate 8. The light passes through the phosphor film 9 to be converted into light having a desired wavelength. The converted light passes through the prism sheet 5 to be changed to illumination light.

### Third Embodiment

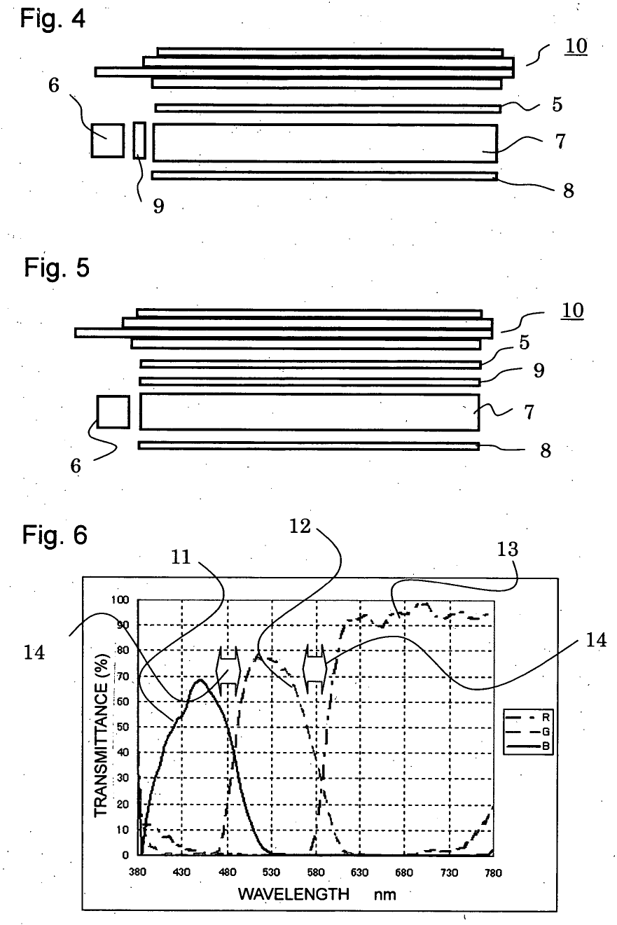

A structure of a display device according to a third embodiment of the invention is schematically shown in FIG. 4. In this embodiment, the side-light type lighting device shown in FIG. 2 is used as a backlight of the display device. A liquid crystal display element is used as a display element. As shown in the figure, the phosphor film 9 is set between the light source 6 and the light guide 7. Light emitted from the light source 6 passes through the phosphor film 9 to be converted into light having a desired wavelength. The converted light is guided in a direction of a liquid crystal display element 10 by the light guide 7, the reflection plate 8, and the prism sheet 5 and sampled by a color filter provided in the liquid crystal display element 10 to emit light of a display color.

Transmittance characteristics of the color filter of the liquid crystal display element are shown in FIG. 6. A transmittance characteristic of a blue color filter in the color filter is indicated by a curve 11, a transmittance characteristic of a green color filter is indicated by a curve 12, and a transmittance characteristic of a red color filter is indicated by a curve 13. A region where the curve 11 and the curve 12 overlap and a region where the curve 12 and the curve 13 overlap are cut regions 14. A wavelength characteristic of a white LED is shown in FIG. 7. Referring to FIGS. 6 and 7, it is found that, although a secondary peak of a wavelength of the white LED serving as a light source is at about 570 nm, since the secondary peak is in a cut wavelength region of the color filter, energy efficiency is extremely low.

An example of a wavelength conversion characteristic of the phosphor film according to the invention is shown in FIG. 8. A curve 15 indicates an excitation wavelength of the phosphor film. The excitation wavelength has a peak at 480 nm. As it is also found from FIG. 6, most part of this wavelength is located in a region cut by the color filter. In other words, most of light having the excitation wavelength of the phosphor film is originally light absorbed by the color filter. On the other hand, a wavelength of light emitted by the phosphor film (a curve 16) is located in a region of a transmission wavelength of the red color filter. In other words, light having a wavelength excited in displaying red and white is effectively used without being absorbed by the color filter.

In selecting a phosphor of the phosphor film, an excitation wavelength having a peak at 580 nm may be selected. A peak of a luminescent wavelength only has to avoid 480 nm to 510 nm and 570 nm to 590 nm. In other words, an excitation wavelength of a phosphor used in the phosphor film only has to be in a region of wavelengths absorbed by the color filter, and a luminescent wavelength only has to avoid a region where absorption by the color filter is large. According to the invention, it is possible to effectively use light from the light source.

When a luminescent wavelength of the phosphor has a peak at 600 nm or more, it is possible to compensate for a wavelength region where a ratio of light emission from the white LED is low. Thus, color reproducibility is increased.

A display device having a structure in which the phosphor film 9 is arranged on an upper surface of the light guide 7 is shown in FIG. 5. The same effect is obtained when the phosphor film 9 is placed between the light guide 7 and the reflection plate 8. In other words, if the phosphor film 9 is set in any one of optical paths of the light emitted from the light source 6 reaching the liquid crystal display element 10, it is possible to obtain the effect of the invention. A diffuser and plural prism sheets may be placed on the upper surface of the light guide 7. A combination of components placed on the upper surface of the light guide 7 is changed according to necessary luminance and viewing angle characteristics.

In the above explanation, the white LED is used as the light source 6. However, a CCFL (cold-cathode fluorescent lamp) may be used. In a rare case, a blue LED is used as the light source 6 and a film applied with a phosphor for emitting yellow light is placed on the light guide 7 to obtain white light. Even in such a case, the invention is effective. However, it is necessary to arrange the phosphor film 9 on an optical path after light is whitened.

In the invention, since the phosphor film that converts light absorbed by the color filter into light transmitted through the color filter is used, it is possible to realize a lighting device with high luminance efficiency. Since a phosphor having a wavelength less included in a white light source as a luminescent wavelength is selected, it is possible to realize a lighting device with extremely high color reproducibility. In other words, there is an effect that it is possible to use the phosphor film for wavelength conversion for light from light sources in many applications and promote a reduction in power consumption of a color light source and improvement of color reproducibility.

Since the lighting device of the liquid crystal display device according to this embodiment described above is resistible against humidity in the environment, the lighting device is suitable for a liquid crystal display device used under a high-temperature and high-humidity environment such as a liquid crystal display device mounted on a vehicle in summer. It is possible to realize a wall-hanging lighting device with low power consumption by applying the lighting device according to this embodiment to a flat lighting device used in a general room or the like. There is an effect that a general lighting environment is improved and saving of resources is possible.

### Fourth Embodiment

As a material forming the non-permeable layer 3 shown in FIG. 1, it is possible to use silicon resin, cycloolefin resin, fluoride resin, and the like. It is also possible to use inorganic non-permeable materials such as glass sol and silicon dioxide. Although larger thickness of the non-permeable layer 3 is better, the non-permeable layer 3 works at thickness of about 5 μm or larger In particular, when a polymeric non-permeable layer is used, thickness only has to be equal to or larger than about 20 μm, desirably, equal to or more than 50 μm.

The transparent film 1 is formed from a translucent polymeric material having thickness of about 25 μm to 500 μm. As the translucent polymeric material, it is possible to use usual resin such as PET (polyethylene terephthalate), PC (polycarbonate), acrylic resin, or TAC (triacetyle-cellulose). As the binder 2, it is possible to use an acrylic adhesive, an epoxy adhesive, or the like. These adhesives may be a heat-hardening adhesive, an ultraviolet curing adhesive, or an air-setting adhesive. The usual resin used as the transparent film 1 has high water permeability. Thus, in particular, when thickness of the transparent film 1 is as small as 25 μm to 100 μm, it is preferable to use silicon resin, cycloolefin resin, or fluoride resin as the non-permeable layer.

A material of the phosphor particles 4 is appropriately selected and used according to an excitation light wavelength to be used and a target luminescent wavelength. For example, if blue light is used as excitation light and a yellow phosphor that converts blue light into yellow light is used as the phosphor particles 4 to adjust intensity of the blue light serving as the excitation light, light having desired chromaticity is obtained through additive mixture of color of the excitation light and the wavelength-converted light.

### First Specific Example

A PET film with thickness of 200 μm was used as a transparent film. A phosphor obtained by mixing S-base green phosphor particles and S-base red phosphor particles in epoxy resin at a ratio of 1:1 to have total weight concentration of 40% with respect to the epoxy resin was applied on the PET film. This phosphor layer was coated with silicon resin with thickness of 100 μm. Under the environment of 90% and 60° C., a change in chromaticity of film transmitted light obtained by irradiating blue light from a blue LED on this sample was checked while the chromaticity was measured. Then, whereas a similar sample in which a non-permeable layer was not formed was deteriorated in 24 hours, no deterioration was observed in this sample in 1000 hours.

### Second Specific Example

Cycloolefin resin (Zeonor: name of a product manufactured by Zeon Corporation) with thickness of 200 μm was used as a transparent film to form the same phosphor layer the same as the first specific example. This phosphor layer was coated with PTFE (tetrafluoroethylene resin) enamel with thickness of 100 μm. When this sample was examined in the same manner as the first specific example, no deterioration was observed in 1000 hours.

### Fifth Embodiment

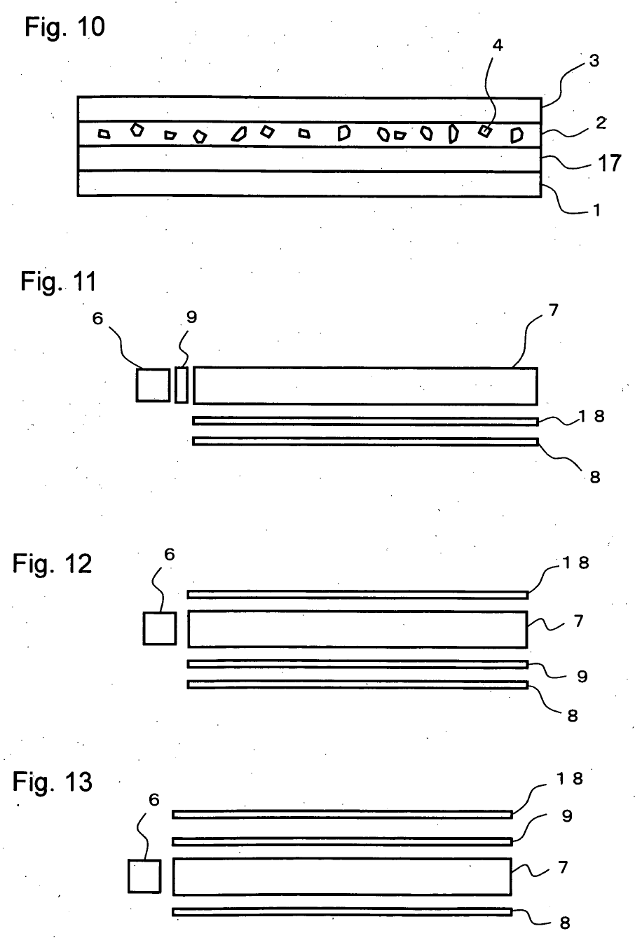

A sectional structure of a phosphor film according to a fifth embodiment of the invention is schematically shown in FIG. 10. This embodiment is different from the first embodiment in that a second non-permeable layer 17 is formed on the transparent film 1. As the second non-permeable layer 17, it is possible to use the same material as the non-permeable layer 3. Since the second non-water-permeable layer 17 is formed in this way, it is possible to obtain a satisfactory waterproof effect even if a usual translucent film material such as PC is used for the transparent film 1.

### Third Specific Example

Silicon dioxide sol was formed to have thickness of 5 μm on a PET film to have thickness of 50 μm and the same phosphor layer as the first specific example was formed to have thickness of 100 μm on the silicon dioxide sol. An epoxy adhesive containing fluorine was applied on the phosphor layer and hardened to form the non-permeable layer 3 with thickness of 120 μm. When a change in a luminescent color of this sample was observed in the same manner as the first specific example and the second specific example, no deterioration was observed over 1000 hours or more.

### Fourth Specific Example

In the same manner as the third specific example, silicon dioxide sol was formed to have thickness of 2 μm on a PFA (tetrafluoroethylene perfluoro vinyl ether copolymer) film with thickness of 100 μm. A phosphor layer and silicon resin containing fluorine were formed to have thickness of 200 μm on the silicon dioxide sol. When chromaticity of a luminescent color was evaluated, no deterioration was observed over 1000 hours or more.

### Sixth Embodiment

FIG. 11 is a sectional view schematically showing a structure of a lighting device according to a sixth embodiment of the invention. As shown in FIG. 11, a first phosphor film 9 is provided between the light source 6 and the light guide 7. A second phosphor film 18 is provided between the reflection plate 8 and the light guide 7.

The light guide 7 is formed from transparent polymer such as acrylic resin, polycarbonate resin, or cycloolefin resin. The light guide 7 leads light from the light source 6 into the light guide 7 from alight incidence surface and propagates the light. In general, a fine prism group and a scattering structure are formed on a light emission surface or a rear surface of the light guide 7. The light guide 7 irradiates uniform light on a plane from the light emission surface. The light source 6 is a blue LED. Usually, two or more light sources are arranged on a light incidence surface of a light guide. In the embodiment shown in FIG. 11, the fine prism group is formed on the rear surface of the light guide 7. Light propagated in the light guide 7 is extracted to the rear surface at a predetermined ratio. Light irradiated from the rear surface is reflected by the reflection plate 8, transmitted through the light guide 7 again, and irradiated from the light emission surface of the light guide 7. As the reflection plate 8, it is possible to use a reflection plate in which a reflection layer deposited with an alloy of Al and Ag or Ag and Pd or the like is formed on a polymeric substrate of PET or the like, a transparent polymeric substrate mixed with a white pigment with high reflectance, or the like.

Phosphor layers using different phosphor particles are applied on the first phosphor film 9 and the second phosphor film 18. The phosphor layers are coated with non-permeable layers. The first phosphor film 9 and the second phosphor film 18 are the phosphor films described in the first embodiment and the fifth embodiment. Specifically, in this embodiment, in the first phosphor film 9, a red phosphor layer for wavelength-converting blue light into red light is applied on a transparent polyethylene terephthalate (PET) film, which is applied with a second non-permeable layer, with a transparent silicon resin binder or epoxy resin binder as a binder. A first non-permeable layer is applied on the surface of the red phosphor layer. In the second phosphor film 18, a green phosphor layer for wavelength-converting blue light into green light is applied on a transparent PET film, which is applied with the second non-permeable layer 17, with a transparent silicon resin binder as a base material. The first non-permeable layer 3 is applied on the surface of the green phosphor layer.

Since light irradiated on the second phosphor film 18 has uniform intensity, it is possible to apply the phosphor layer on the second phosphor film 18 with uniform thickness. The phosphor layer applied on the first phosphor film 9 only has to be applied at least in an area where light from the light source 6 is irradiated.

On the other hand, in general, when light of a short wavelength is wavelength-converted, wavelength conversion efficiency falls as a wavelength of light obtained by wavelength conversion increases. Therefore, when it is attempted to obtain converted light with the same light intensity, it is necessary to increase iradiation light intensity as a converted wavelength increases. Therefore, it is possible to efficiently convert blue light into red light by arranging a red phosphor near the light source 6. An absorption coefficient for red light of the transparent polymeric material forming the light guide 7 is high compared with those for green light and blue light. Thus, it is possible to reduce a loss of the red light until irradiation even if an optical path after the conversion is long.

On the other hand, a green phosphor for wavelength-converting blue light into green light has higher wavelength conversion efficiency than the red phosphor. Thus, the green phosphor is arranged in the second phosphor film 18 to perform uniform wavelength conversion.

With such a structure, it is possible to realize a lighting device that has a large colorimetric range and is excellent in resistance to humidity.

### Seventh Embodiment

A structure of a lighting device according to a seventh embodiment of the invention is schematically shown in FIG. 12. In this embodiment, the first phosphor film 9 is arranged on the rear surface of the light guide 7 and the second phosphor film 18 is arranged on the front surface of the light guide 7. A blue LED with a luminescent wavelength of 460 nm is used as a light source. A red phosphor is used for the first phosphor film 9 and a green phosphor is used for the second phosphor film 18. With such a structure, it is possible to realize a lighting device that is excellent in resistance to humidity and has a large calorimetric range.

Blue light passing through the first phosphor film 9 is used twice as iradiation light from the light guide 7 side and reflected light from the reflection plate 8 side. Thus, compared with the case in which the blue light is wavelength-converted only once, it is possible to halve a concentration of a phosphor contained in the first phosphor film 9.

In this embodiment, light propagated in the light guide 7 is substantially only the blue light. Thus, it is possible to make it easy to design a structure of a light guide for irradiating light from a light emission surface, thereby improve lighting efficiency, and reduce a design delivery time. Consequently, as means for extracting light propagated in the light guide 2 to the outside and irradiating the light, it is possible to efficiently use a hologram other than using a fine prism group or a fine scattering structure on the light emission surface or the rear surface of the light guide 7. It is possible to easily manufacture the hologram by transferring a pattern obtained by a two-beam interference fringe through lithography or forming a computer hologram such as a Lippmann hologram through lithography.

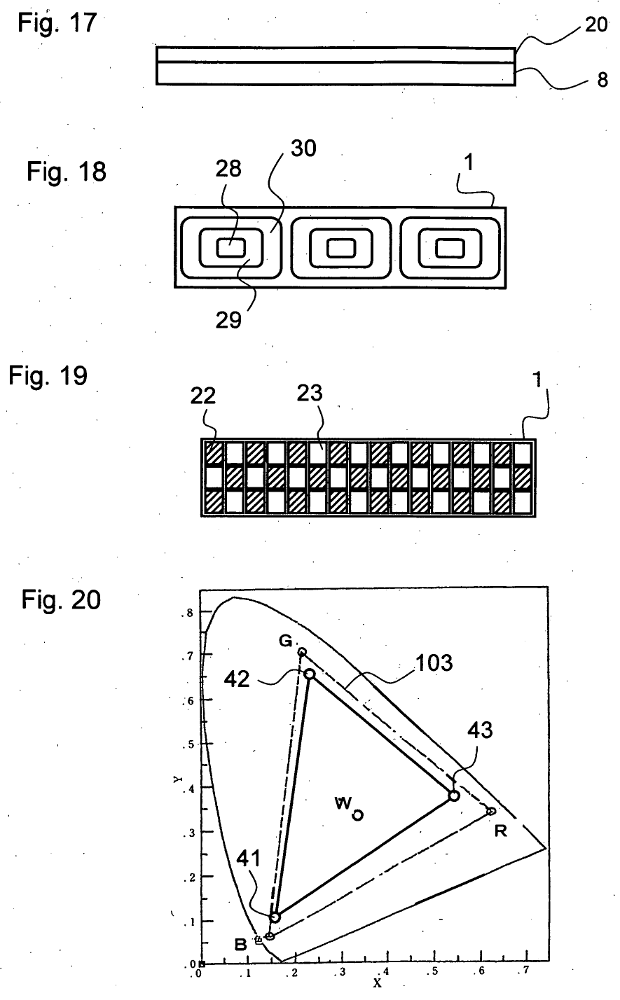

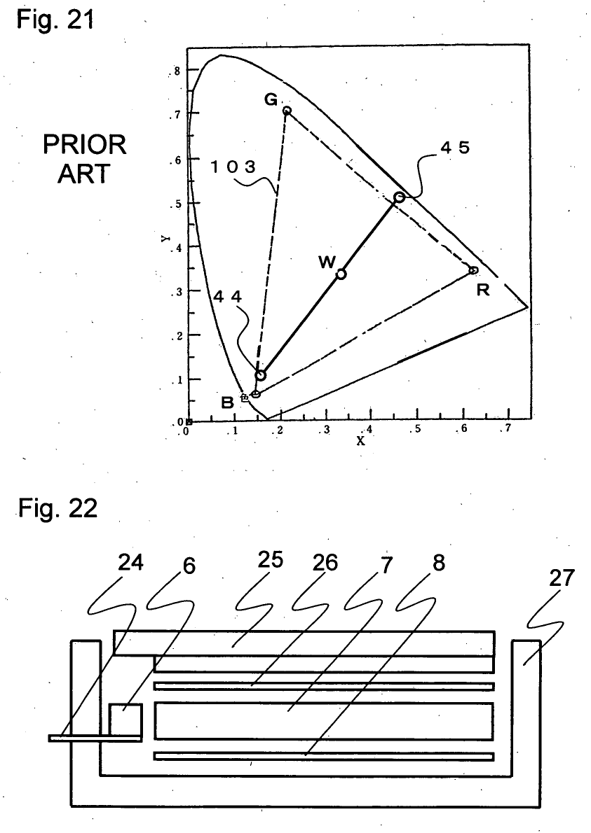

In this embodiment, it is also possible to form a phosphor layer directly on a reflection surface of a reflection plate. As shown in FIG. 17, a phosphor layer 20 is formed oh the surface of the reflection plate 8.

### Eighth Embodiment

FIG. 13 is a schematic sectional view showing a structure of a lighting device according to a eighth embodiment of the invention. This embodiment is different from the seventh embodiment in that both the first phosphor film 9 and the second phosphor film 18 are arranged on the light emission surface side of the light guide 7. A light intensity distribution of light emitted from the light guide 7 has uniformity equal to higher than 70%. Thus, with such an arrangement, it is possible to uniformalize excitation light intensity obtained through wavelength conversion by the first phosphor film 9 and the second phosphor film 18 and improve a color mixture property. Moreover, it is possible to improve wavelength conversion efficiency by using a red phosphor for the first phosphor film 9 and a green phosphor for the second phosphor film 18.

Compared with the case in which a usual phosphor film not coated with a non-permeable layer is used, it is possible to realize a lighting device excellent in resistance to humidity by using the phosphor film according to the invention.

### Ninth Embodiment

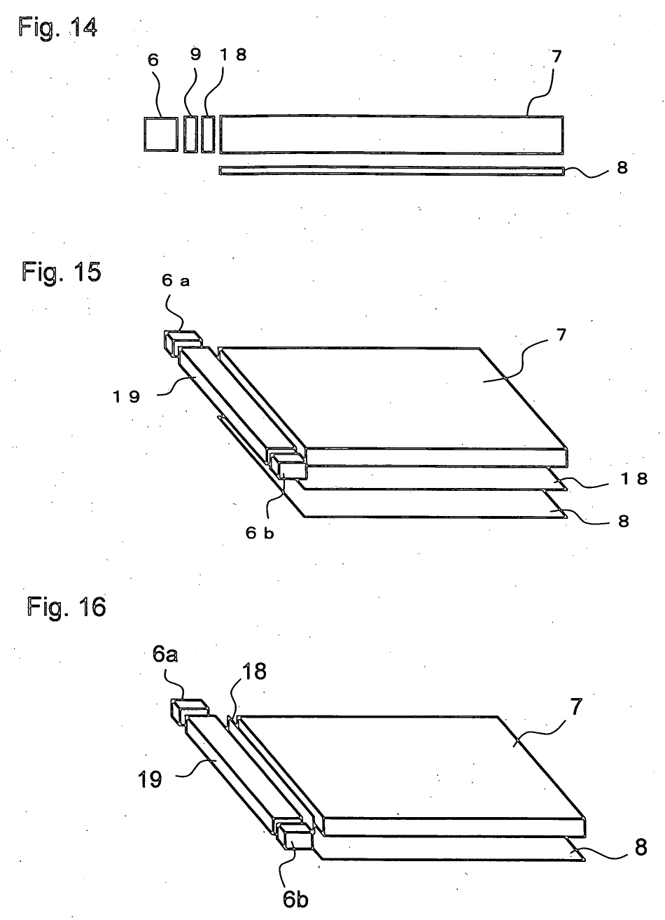

A schematic sectional structure of a lighting device according to a ninth embodiment of the invention is shown in FIG. 14. In this embodiment, the first phosphor film 9 and the second phosphor film 18 are provided between the light source 6 and the light incidence surface of the light guide 7. In this case, as in the eighth embodiment, it is possible to improve wavelength conversion efficiency by using a red phosphor for the first phosphor film 9 and using a green phosphor for the second phosphor film 18.

In this embodiment, since the first phosphor film 9 and the second phosphor film 18 are close to the light source 6, a light intensity distribution of light irradiated on these phosphor layers is large. Since light intensity of light wavelength-converted in these phosphor layers and emitted is high in a portion where intensity of excitation light is high, color irregularity occurs when colors are mixed in the light guide. Thus, thickness of a phosphor applied on the phosphor layers is reduced in a portion where light irradiation intensity of the excitation light is high, while being increased in a portion where light irradiation intensity of the excitation light is low, to thereby obtain substantially fixed ratio of the excitation light and emitted light obtained by wavelength conversion.

It is possible to use, as the light source 6, a light source in which an ultraviolet LED for emitting a near ultraviolet ray and a blue LED for emitting blue light are arranged close to each other. The ultraviolet LED has a luminescent wavelength of, for example, 365 nm. Since excitation energy given to a phosphor is large, it is possible to perform highly efficient wavelength conversion. However, an ultraviolet ray is absorbed in a large quantity by components of the lighting device such as a polymeric material forming the light guide 7. Thus, it is difficult to propagate the ultraviolet ray in the light guide and uniformly excite the phosphor in a large area. Therefore, as shown in FIG. 14, if a phosphor layer is arranged in a space between the ultraviolet LED and the light guide 7 and visible light after conversion is propagated in the light guide, efficiency is improved.

FIG. 18 is a plan view schematically showing a concentration distribution of a phosphor applied on the first phosphor film 9 and the second phosphor film 10 in the case in which three light sources are arranged in parallel. In FIG. 18, concentration of phosphor particles increases in an order of areas 28, 29, and 30. The area 28 corresponds to a luminance center of the light source and has highest radiation light intensity. The radiation light intensity falls in a portion farther away from the luminance center. In general, a phosphor has higher wavelength conversion efficiency and a larger number of converted light components as the irradiation light increases. Therefore, it is possible to obtain illumination light with a uniform color distribution by increasing concentration of the phosphor in a portion farther away from the luminance center of the light source in this way. In the figure, an area of each of the light sources is divided into three areas 28, 29, and 30. However, it is possible to improve a color distribution when the area is divided into a larger number of areas.

It is possible to obtain such an area by sequentially printing phosphor layers with different phosphor concentrations using printing plates corresponding to the respective areas through screen printing or offset printing. In the phosphor film 9, non-permeable layers are formed on the phosphor layers formed in this way to prevent moisture in the environment from affecting the phosphor particles.

In this way, a distribution is provided in concentration of the phosphor forming the first phosphor film 9 and the second phosphor film 18 in FIG. 14. This makes it possible to obtain a lighting device that is excellent in resistance to humidity and has satisfactory high calorimetric property and satisfactory color mixture.

### Fifth Specific Example

In FIG. 14, three light sources 6 in which an ultraviolet LED and a blue LED were provided close to each other and encapsulated in one package were arranged in parallel. A luminescent wavelength of the ultraviolet LED was set to 365 nm and a luminescent wavelength of the blue LED was set to 460 nm. Red phosphor particles having the distribution shown in FIG. 18 and mixed in a binder were screen-printed on a transparent film at five stages of concentration and hardened. Epoxy resin containing fluorine was further applied on the red phosphor particles and hardened to form the first phosphor film 9. As the second phosphor film 18, a phosphor film obtained by printing and hardening a green phosphor and coating the green phosphor with epoxy resin containing fluorine in the same manner as the first phosphor film 9 was used.

In this way, the red phosphor and the green phosphor were excited by the ultraviolet LED and light from the phosphor was mixed with blue light from the blue LED. Consequently, a lighting device having a large color reproduction range and a satisfactory color mixture property could be obtained. In particular, an ultraviolet ray used as excitation light did not affect color reproduction. The mixture of red light and green light excited and blue light from a blue light source only had to be considered. Thus, a lighting device in which color adjustment was easy could be obtained.

An ultraviolet ray facilitates deterioration of polymeric materials of the light guide 7, which is a component of the lighting device. When light mixed with the ultraviolet ray is irradiated on a liquid crystal device, liquid crystal is deteriorated. Moreover, eyes of an observer are adversely affected. Thus, although not clearly shown in FIG. 14, in this specific example, an ultraviolet ray absorbing film was inserted between the second phosphor film 18 and the light incidence surface of the light guide 7.

### Tenth Embodiment

FIG. 15 is a perspective view schematically showing a structure of alighting device according to a tenth embodiment of the invention. In this embodiment, two blue light sources 6a and 6 are arranged on both side ends of a light pipe 19. Light beams emitted from these blue light sources are propagated through the light pipe 19 and uniformalized, deflected, by a prism formed on a surface of the light pipe 19 opposed to the light guide 7 or an opposite surface of the surface, uniformly irradiated on the light incidence surface of the light guide 7, and guided to the inside of the light guide 7. In the lighting device according to this embodiment, a red phosphor is mixed in the light pipe 19. Consequently, blue light is wavelength-converted into red light in the light pipe 19 and it is possible to realize uniform wavelength conversion and color mixture. Besides being repeatedly reflected in the light pipe 19, the blue light has high light intensity. This makes it possible to perform efficient wavelength conversion. A non-permeable layer (not shown) is formed on the entire surface of the light pipe 19 to prevent red phosphor particles in the red pipe 19 from being deteriorated by moisture in the environment.

On the other hand, the second phosphor film 18 shown in the first embodiment or the fifth embodiment is arranged on the rear surface of the light guide 7. A green phosphor layer is uniformly formed on the surface of the second phosphor film 18. Moreover, the surface of the green phosphor layer is coated with a non-permeable layer. With such a structure, it is possible to realize a lighting device that is excellent in resistance to humidity and has satisfactory calorimetric property and color mixture property.

### Eleventh Embodiment

FIG. 16 is a perspective view schematically showing a structure of a lighting device according to an eleventh embodiment of the invention. This embodiment is different from the seventh embodiment in that the second phosphor film 18 is inserted between the light pipe 19 and the light incidence surface of the light guide 7. As explained in the seventh embodiment, the red phosphor mixed in the light pipe 19 efficiently wavelength-converts blue light into red light using uniform and intense blue light in the light pipe 19. It is possible to mix the blue light and the red light sufficiently uniformly inside of the light pipe. Moreover, since light emitted from the light pipe 19 to the light incidence surface side of the light guide 7 is uniform, a phosphor layer applied on the second phosphor film 18 only has to be uniform. Compared with the seventh embodiment, since intensity of light irradiated on the second phosphor film 18 is high, there is an advantage that it is possible to efficiently convert the blue light into green light. Since it is possible to reduce an area of the second phosphor film 18 compared with the seventh embodiment, it is possible to reduce a quantity of phosphor to be used and reduce manufacturing cost for the lighting device.

In this way, in this embodiment, as in the embodiments described above, it is possible to realize, using a smaller quantity of phosphor, a lighting device that is excellent in resistance to humidity and has satisfactory calorimetric property and color mixture property.

### Twelfth Embodiment

In the eleventh embodiment shown in FIG. 16, the phosphor applied on the surface of the second phosphor film 18 only has to be uniform. In this case, for example, when blue light is wavelength-converted by a red phosphor to obtain red light, since energy necessary for wavelength conversion is absorbed, intensity of the blue light falls. It is not efficient to irradiate the blue light with lower intensity on a green phosphor to wavelength-convert the blue light into green light. Thus, in this embodiment, areas of the red phosphor and the green phosphor are divided on the film surface and selectively printed on the second phosphor film 18 not to overlap each other. This makes it possible to effectively use excitation light. A specific arrangement of a red phosphor area and a green phosphor area is shown in FIG. 19. As shown in FIG. 19, a red phosphor applied area 22 and a green phosphor applied area 23 are printed on the transparent film 1 to be spaced apart from each other. A binder having the red phosphor or the green phosphor dispersed in respective areas is printed using a screen of a pattern shown in FIG. 19. The binder is further coated with a non-permeable layer. With such a structure, it is possible to effectively perform wavelength conversion for two wavelengths from one light source by using one phosphor film without mixing and dispersing a phosphor in the light pipe 19. The respective phosphors can perform wavelength conversion with an excitation light of satisfactory intensity without absorbing excitation light to weaken intensity of each other.

In FIG. 19, a shape of areas to be divided does not always have to be rectangular and may be a dot shape or a polygonal shape. It is possible to easily adjust intensity of light to be wavelength-converted by adjusting an area density of the divided areas. Thickness of a phosphor layer to be printed and concentration of phosphor particles dispersed in a binder may be changed.

In order to perform sufficient color mixture, it is preferable that a printing area is as small as possible. It is possible to adjust a size of the printing area to an arbitrary size in a range of 50 μm to 200 μm and perform sufficient color mixture by using screen printing, offset printing, or a printing method by ink jet. It is possible to easily realize formation of a phosphor layer substantially having the phosphor concentration distribution shown in FIG. 18 by changing a size of the printing area and changing phosphor particle concentration of the respective areas.

It goes without saying that it is possible to disperse and form phosphor formation areas even when a phosphor layer is not arranged in a space between a light source and a light incidence surface of a light guide.

As described above, it is possible realize the lighting device according to the invention as a lighting device that is excellent in resistance to humidity and has satisfactory colorimetric property and color mixture property. By using the lighting device in a high-definition liquid crystal display device, it is possible not only to improve a colorimetric property and resistance to humidity of the liquid crystal display device but also to realize an increase in luminance.

It goes without saying that it is possible to use the phosphor film and the lighting device according to the invention not only as a lighting device of a liquid crystal display device but also as a general flat light source and a general lighting device.

### Thirteenth Embodiment

A structure of a display device according to a thirteenth embodiment of the invention is schematically shown in FIG. 22. The lighting device having the structure explained in the embodiments described above is provided to light a liquid crystal display element. A diffuser 26 is arranged above the light guide 7 and a liquid crystal display element 25 is provided above the diffuser 26. The reflection plate 8 is provided below the light guide 7. These components are protected and held by a housing 27. The light source 6 mounted on a wiring substrate 24 is arranged at one end face of the light guide 7. The light source 6 is opposed to the light guide 7 without misregistration. Although not shown in FIG. 22, it goes without saying that a phosphor film is arranged in some place around the light guide 7 in the same manner as the embodiments described above.

What is claimed is:

1. A lighting device, comprising:
a light source;
phosphor particles that are excited by light from the light source and emit light having a wavelength different from that of the light from the light source;
a light guide that propagates the light from the light source and irradiates the light in a plane shape; and
a phosphor layer formed by mixing the phosphor particles in a binder,
wherein the phosphor layer is sandwiched between a translucent film and a non-permeable layer.

2. A lighting device according to claim 1, further comprising an optical element on an emission surface side of the light guide,
wherein the phosphor particles have a characteristic that the phosphor particles are excited by light in a region, which does not pass through the optical element, of a wavelength region of the light emitted from the light source and emit light having a wavelength passing through the optical element.

3. Alighting device according to claim 2, wherein the phosphor layer is provided between the light source and the light guide.

4. A lighting device according to claim 2, wherein the phosphor layer is provided above the emission surface of the light guide.

5. A lighting device according to claim 2, further comprising a reflection plate on a rear side of the light guide,
wherein the phosphor layer is provided between the light guide and the reflection plate.

6. A lighting device according to claim 1, wherein:
the light source comprises a blue light source; and
the phosphor particles include green phosphor particles that convert blue light into green light and red phosphor particles that convert blue light into red light.

7. A lighting device according to claim 6, wherein:
the light source includes an ultraviolet light source and a blue light source; and
the phosphor particles comprise green phosphor particles that convert an ultraviolet ray into green light and red phosphor particles that convert an ultraviolet ray into red light.

8. A lighting device according to claim 1, wherein the phosphor layer includes:
a first phosphor layer including first phosphor particles that are excited by the light from the light source and emit light in a first wavelength range; and
a second phosphor layer including second phosphor particles that are excited by the light from the light source and emit light in a second wavelength range.

9. A lighting device according to claim 8, wherein one of the first phosphor layer and the second phosphor layer, which emits light having a short wavelength, is arranged on the light source side.

10. A lighting device according to claim 8, wherein:
a reflection plate is provided on a rear side of the light guide;
the first phosphor layer is provided between the light source and the light guide; and
the second phosphor layer is provided between the light guide and the reflection plate.

11. A lighting device according to claim 8, wherein:
a reflection plate is provided on a rear side of the light guide;
the first phosphor layer is provided between the light guide and the reflection plate; and
the second phosphor layer is provided on a light irradiation surface of the light guide.

12. A lighting device according to claim 8, wherein the first phosphor layer and the second phosphor layer are arranged in a plane to prevent an overlap therebetween.

13. A lighting device according to claim 6, wherein:
the phosphor layer is provided between the light source and the light guide; and
a density of mixture of the phosphor particles is set to be larger in an area closer to the light source.

14. A lighting device according to claim 6, further comprising a light pipe provided between the light source and the light guide to propagate the light from the light source and make the light incident on the light guide in a linear shape, wherein:
the phosphor layer is formed in the light pipe; and
a non-permeable layer is provided to cover an entire surface of the light pipe.

15. A lighting device according to claim 8, further comprising a light pipe provided between the light source and the light guide to propagate the light from the light source and make the light incident on the light guide in a linear shape, wherein:
the first phosphor particles are provided in the light pipe;
a non-permeable layer is provided to cover an entire surface of the light pipe; and
the second phosphor particles are provided between the light pipe and a light incidence surface of the light guide.

16. A lighting device according to claim 1, wherein the translucent film is formed by any one of PET (polyethylene terephthalate), PC (polycarbonate), acrylic resin, and TAC (triacetyle-cellulose).

17. A lighting device according to claim 1, wherein the non-permeable layer comprises at least one of silicon resin, cycloolefin resin, and fluoride resin.

18. A phosphor film, comprising:
phosphor particles that are excited by light made incident thereon and emit light having a wavelength different from that of the light; and
a phosphor layer formed by mixing the phosphor particles in a binder,
wherein the phosphor layer is sandwiched between a translucent film and a non-permeable layer.

19. A display device, comprising:
a light source;
phosphor particles that are excited by light from the light source and emit light having a wavelength different from that of the light;
a light guide that makes the light from the light source incident thereon and emits the light from an emission surface;
a phosphor layer in which the phosphor particles are dispersed in a binder;
a translucent film and a non-permeable layer provided to sandwich the phosphor layer; and
a display element provided on the emission surface side of the light guide,
wherein the phosphor particles have a characteristic that the phosphor particles are excited by light in a region, which is cut by a color filter formed in the display element, of a wavelength region of the light emitted from the light source and emit light having a wavelength passing through the color filter.

20. A display device according to claim 19, wherein:
the light source emits pseudo-white light including two peaks in a visible light region;
the color filter is formed of red, green, and blue filters; and
the phosphor is excited by light of 480 nm to 490 nm and emits light of 600 nm.

21. A display device according to claim 19, wherein:
the light source emits pseudo-white light including two peaks in a visible light region; and
the phosphor is excited by light in a wavelength region of one peak and emits light in a wavelength region other than the two peaks.
